(19) United States
(12) Patent Application Publication
(10) Pub. No.: US 2015/0109463 A1
(43) Pub. Date: Apr. 23, 2015

(54) METHOD AND SYSTEM FOR GENERATING MODIFIED DISPLAY DATA

(71) Applicant: MOTOROLA SOLUTIONS, INC, Schaumburg, IL (US)

(72) Inventors: JAMES R. MORLEY-SMITH, HIGH WYCOMBE (GB); MARK T. FOUNTAIN, LONDON (GB); EDWARD A. HACKETT, SURBITON (GB); BENEDICT J.H. KENNEDY, BASINGSTOKE (GB)

(73) Assignee: MOTOROLA SOLUTIONS, INC, Schaumburg, IL (US)

(21) Appl. No.: 14/058,218

(22) Filed: Oct. 19, 2013

(51) Int. Cl. G09G 5/37; G09G 5/36; G09G 5/02

(52) U.S. Cl. CPC G09G 5/37; G09G 5/02; G09G 5/363; G09G 2320/0613; G09G 2320/0666
USPC 348/207.1; 345/589

(57) ABSTRACT

Disclosed herein are embodiments of a method and system for generating modified display data. One embodiment takes the form of a method, carried out by a display controller, that includes receiving display data having defined therein one or more received-display-data regions of respective pre-defined color values, and further includes generating modified display data based on the received display data, and also includes outputting the modified display data for presentation via a user interface. Generating the modified display data based on the received display data involves, with respect to each defined received-display-data region: using the pre-defined color value of the received-display-data region to select a visual effect based on configuration data that maps various pre-defined color values to various visual effects, and applying the selected visual effect to the received-display-data region in a corresponding modified-display-data region in the modified display data.

### BACKGROUND

Wireless communication and mobile technology are quite prevalent in modern society, and becoming more so all the time. Millions of people around the world use numerous types of wireless-communication devices to communicate with other communication devices, including other wireless-communication devices, both directly and/or via one or more networks. In a typical arrangement, a user interacts with a portable and mobile wireless-communication device known by terms such as mobile station, mobile subscriber unit, access terminal, user equipment (UE), cell phone, smartphone, tablet, and the like. For illustration and not by way of limitation, this disclosure uses access terminals as example wireless-communication devices.

Furthermore, such a device typically communicates over a defined air interface with one or more entities of what is known and referred to herein as a radio access network (RAN), which may also be known by terms such as (and/or form a functional part of) a cellular wireless network, a cellular wireless telecommunication system, a wireless wide area network (WWAN), and the like.

Moreover, many modern access terminals include multiple useful components and/or devices for enhancing user experiences. Such components and/or devices include features like a high-quality display (that is often a touchscreen), a camera for capturing images and/or video, and many other features too numerous to list. For generating data to display to a user, access terminals typically implement a display driver of some sort, where different display drivers are implemented with different mixes of hardware and software/firmware. A general purpose and/or graphics processor may form a functional part of a given display driver, as may one or more executable (and often updateable) instruction sets.

### BRIEF DESCRIPTION OF THE FIGURES

The accompanying figures, where like reference numerals refer to identical or functionally similar elements, together with the detailed description below, are incorporated in and form part of the specification, and serve to further illustrate embodiments of the following claims, and explain various principles and advantages of those embodiments.

FIG. 1 depicts an example communication system.

FIG. 2 depicts an example RAN.

FIG. 3 depicts an example access terminal.

FIG. 4 depicts example configuration data.

FIG. 5 depicts an example method.

FIG. 6 depicts a first example of display data.

FIG. 7 depicts a second example of display data.

FIG. 8 depicts an example of an access terminal presenting modified display data.

FIG. 9 depicts a third example of display data.

Those having skill in the relevant art will appreciate that elements in the figures are illustrated for simplicity and clarity, and have not necessarily been drawn to scale. For example, the dimensions of some of the elements in the figures may be exaggerated relative to other elements to help to improve understanding of various embodiments. Furthermore, the apparatus and method components have been represented where appropriate by conventional symbols in the figures, showing only those specific details that are pertinent to understanding the disclosed embodiments so as not to obscure the disclosure with details that will be readily apparent to those having skill in the relevant art having the benefit of this description.

### DETAILED DESCRIPTION

Disclosed herein are embodiments of a method and system for generating modified display data. One embodiment takes the form of a method, carried out by a display controller, that includes receiving display data having defined therein one or more received-display-data regions of respective pre-defined color values, and further includes generating modified display data based on the received display data, and also includes outputting the modified display data for presentation via a user interface. Generating the modified display data based on the received display data involves, with respect to each defined received-display-data region: using the pre-defined color value of the received-display-data region to select a visual effect based on configuration data that maps various pre-defined color values to various visual effects, and applying the selected visual effect to the received-display-data region in a corresponding modified-display-data region in the modified display data.

Another embodiment takes the form of a display controller equipped and configured with suitable hardware and instructions executable by a processor for carrying out the functions set forth above in connection with the above-described method embodiment.

Another embodiment takes the form of a display controller that forms a functional part of a handheld wireless-communication device that also has an onboard video camera, where the display controller is equipped and configured with suitable hardware and instructions executable by a processor for carrying out the following functions: receiving display data having defined therein a particular received-display-data region of a particular pre-defined color value; generating modified display data based on the received display data; and outputting the modified display data for presentation via a user interface, where generating the modified display data based on the received display data comprises: using the particular pre-defined color value of the particular received-display-data region to select the onboard video camera based on configuration data that maps at least one pre-defined color value to at least one video source, including mapping the particular pre-defined color value to the onboard video camera; and replacing the particular pre-defined color value with a video feed from the onboard video camera in a corresponding modified-display-data region in the modified display data. These and other embodiments are further described below in connection with the figures.

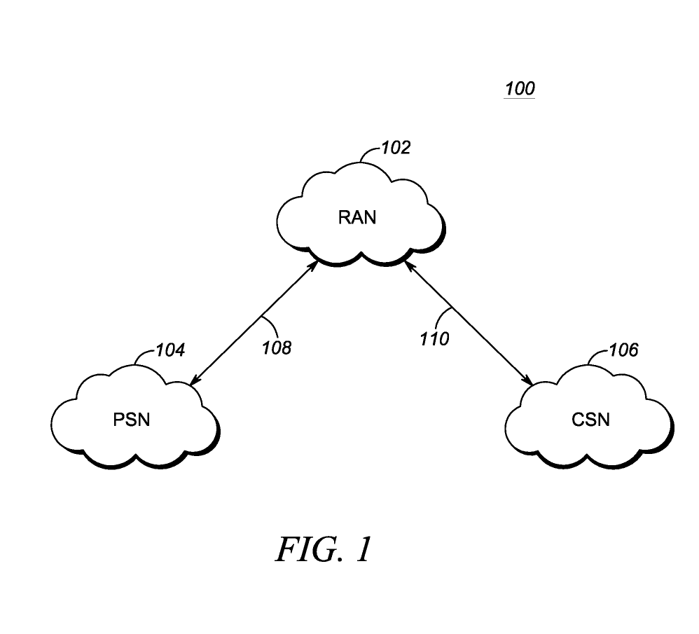

FIG. 1 depicts a communication system 100 as including a RAN 102, a packet-switched network (PSN) 104, and a circuit-switched network (CSN) 106. RAN 102 and PSN 104 are connected by a communication link 108, while RAN 102 and CSN 106 are connected by a communication link 110. Either or both of communication links 108 and 110 could include one or more communication devices, nodes, networks, connections, switches, bridges, routers, and the like. Any or all of communication link 108 and/or any or all of communication link 110 could make use of wired and/or wireless forms of communication. One or more communication links instead of and/or in addition to communication links 108 and 110 could be present. As one example, there could be one or more communication links between PSN 104 and CSN 106.

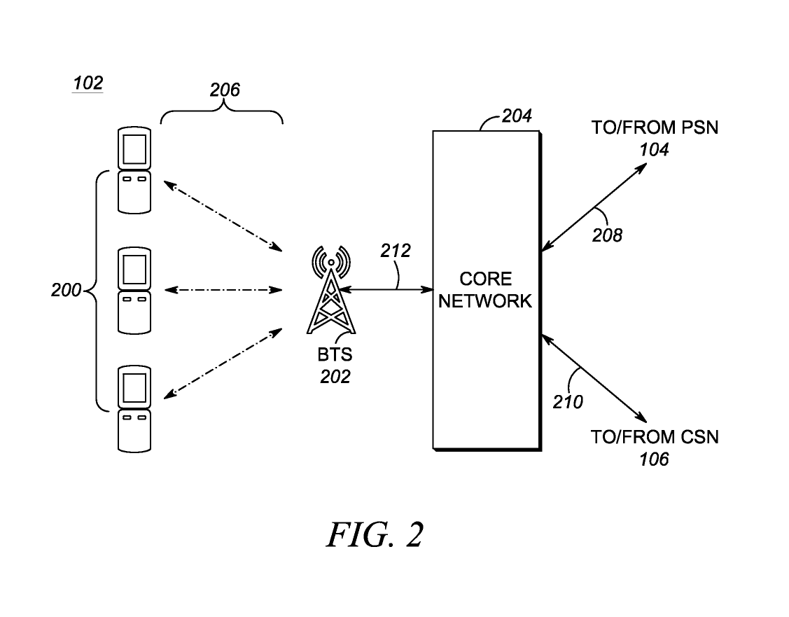

RAN 102 is also discussed in connection with FIG. 2, but in general could be any RAN equipped and configured by those of skill in the relevant art to function as described herein. PSN 104 could be the worldwide network of networks typically referred to as the Internet, but could just as well be any other packet-switched network equipped and configured by those of skill in the relevant art to function as described herein. Nodes resident on PSN 104 may be Internet Protocol (IP) nodes and may be addressed using IP addresses. CSN 106 could be the circuit-switched communication network typically referred to as the Public Switched Telephone Network (PSTN), but could just as well be any other circuit-switched network arranged and configured by those of skill in the relevant art to function as described herein.

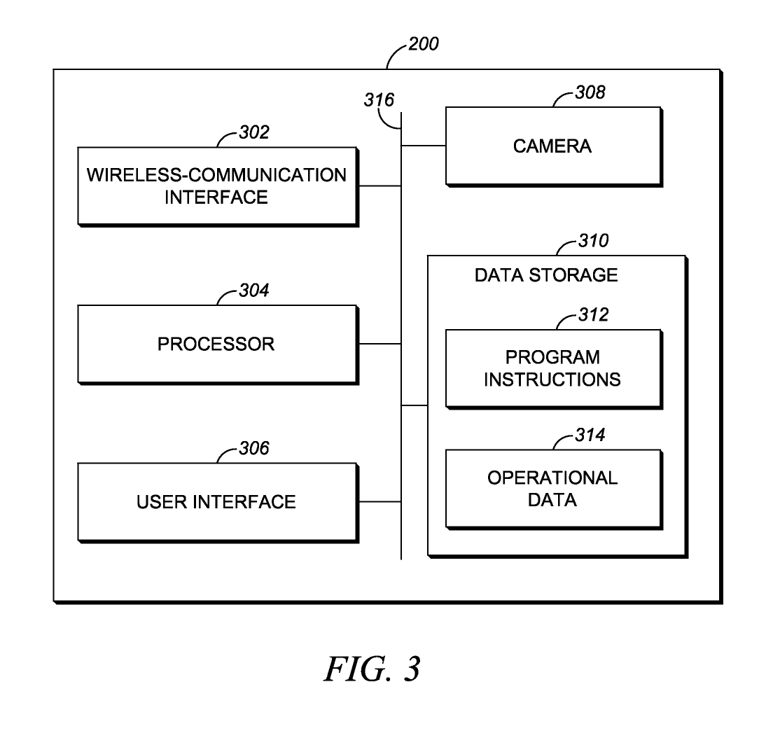

FIG. 2 depicts aspects of an example RAN via which one or more access terminals can communicate. In particular, FIG. 2 depicts RAN 102 of FIG. 1 and further depicts a plurality of access terminals 200 engaged in wireless communication with RAN 102 via an air interface 206. An example access terminal 200 is described more fully below in connection with FIG. 3, though in general any access terminal 200 may be any type of access terminal or other wireless-communication device suitably equipped and configured by those of skill in the relevant art to function as described herein. Furthermore, while certain aspects of RAN 102 are described herein using terminology generally associated with Long Term Evolution (LTE) networks, this is done purely by way of illustration and not by way of limitation, as many protocols could be used.

As shown in FIG. 2, RAN 102 includes a base transceiver station (BTS) 202 (which may also be referred to by a term such as base station or eNodeB) and a core network 204, as well as communication links 208, 210, and 212. BTS 202 may be any network-side entity that is suitably equipped and configured by those of skill in the relevant art to function as described herein, which in general is to provide wireless service to access terminals. Moreover, while three access terminals 200 and one BTS 202 are depicted in FIG. 2, this is by way of illustration and not by way of limitation, as any number of either could be present in a given implementation.

As known to those of skill in the relevant art, core network 204 may include network entities such as one or more mobility management entities (MMES), one or more serving gateways (SGWs), one or more packet data network (PDN) gateways (PGWs), one or more home subscriber servers (HSSs), one or more access network discovery and selection functions (ANDSFs), one or more evolved packet data gateways (ePDGs), and/or one or more other entities deemed suitable to a given implementation by those of skill in the relevant art. Moreover, these entities may be configured and interconnected in a manner known to those of skill in the relevant art to provide wireless service to access terminals via BTSs and to bridge such wireless service with transport networks such as PSN 104 and CSN 106. Air interface 206 may be an LTE air interface having an uplink and a downlink as known to those of skill in the relevant art, though air interface 206 may comply instead or in addition with one or more other protocols.

Communication links 208, 210, and 212 may take any suitable form, such as any of the forms described above in connection with links 108 and 110 of FIG. 1. Communication link 208 may take the form of or include or be connected to link 108 of FIG. 1. A network access server (NAS) (not depicted) may reside between links 108 and 208 to enable and facilitate communications between the two links. Communication link 210 may take the form of or include or be connected to link 110 of FIG. 1. A Voice over IP (VoIP) gateway (not depicted) may reside between links 110 and 210 to bridge circuit-switched communications on link 110 with packet-switched communications on link 210. Communication link 212 may function as what is known as a “backhaul” with respect to BTS 202, as link 212 may enable BTS 202 to bridge (i) communications conducted by BTS 202 with access terminals 200 over air interface 206 with (ii) communications via the rest of RAN 102 and beyond.

FIG. 3 depicts access terminal 200 as including a wireless-communication interface 302, a processor 304, a user interface 306, a camera 308, and data storage 310 (storing program instructions 312 and operational data 314), all of which are communicatively linked by a system bus or other suitable communication path 316. It should be noted that this example architecture of access terminal 200 is presented for illustration and not by way of limitation.

Wireless-communication interface 302 may include components such as one or more antennae, one or more chipsets designed and configured for one or more types of wireless communication (e.g., LTE), and/or any other components deemed suitable by those of skill in the relevant art. Processor 304 may include one or more processors of any type deemed suitable by those of skill in the relevant art, some examples including a general-purpose microprocessor, a dedicated digital signal processor (DSP), and a graphics processor. User interface 306 may include one or more input devices such as touchscreens, microphones, buttons, rocker switches, and the like for receiving user inputs from users, as well as one or more output devices such as displays (which may be integral with one or more touchscreens), speakers, light emitting diodes (LEDs), and the like for presenting outputs to users. Camera 308 may be suitably equipped and configured for capturing images and/or video, as known to those in the relevant art.

Data storage 310 may take the form of any non-transitory computer-readable medium or combination of such media, some examples including flash memory, read-only memory (ROM), and random-access memory (RAM) to name but a few, as any one or more types of non-transitory data-storage technology deemed suitable by those of skill in the relevant art could be used. As depicted in FIG. 3, data storage 310 contains program instructions 312 executable by processor 304 for carrying out various combinations of the access-terminal (and more generally, wireless-communication-device) functions described herein, as well as operational data 314, which may include any type or types of data pertinent to the operation of access terminal 200.

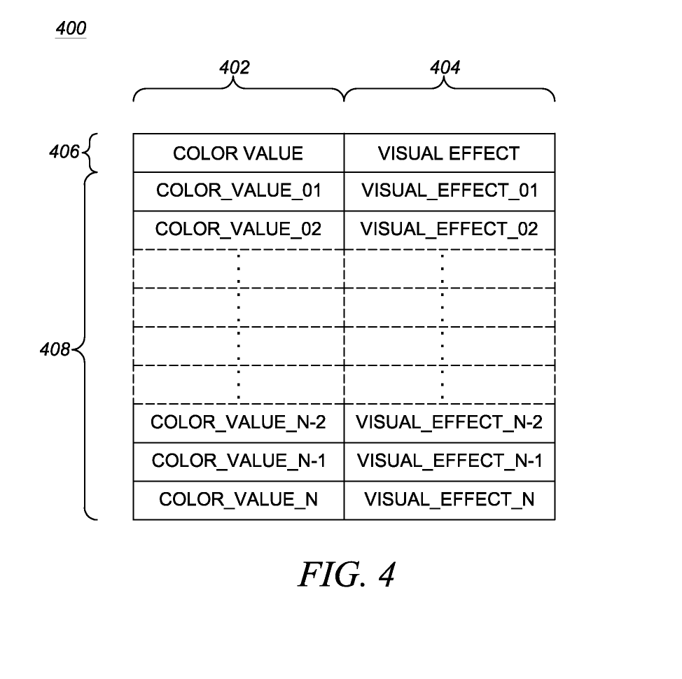

FIG. 4 depicts example configuration data 400, which in at least one embodiment is stored in data storage 310 of FIG. 3, perhaps specifically as part of operational data 314. As depicted in FIG. 4, configuration data 400 takes the logical form of a table having two columns 402 and 404, a title row 406, and N data rows 408. This arrangement, including the arbitrary number N of rows, is included in this disclosure by way of example and not by way of limitation, as any suitable arrangement and any suitable amount of configuration data could be used, as deemed appropriate by those of skill in the relevant art for a given implementation.

As can be seen in FIG. 4, configuration data 400 includes a column 402 entitled “COLOR VALUE” and a column 404 entitled “VISUAL EFFECT,” and further includes N mappings of color values (color_value_{—}01 through color_value_N) to visual effects (visual_effect_{—}01 through visual_effect_N). Some possible forms that one, some, or all of the color values and visual effects listed in FIG. 4 could take are discussed below. These possible forms are described in this disclosure for illustration and not by way of limitation. As one example provided here by way of preview, color_value_{—}01 could equal pure green in the red-green-blue (RGB) notation, where pure green may be listed in that notation as {0, 255, 0}, while visual_effect_{—}01 could equal “replace with feed from onboard video camera 308.” This example is given additional context in—and is thus clarified in light of—the discussion below.

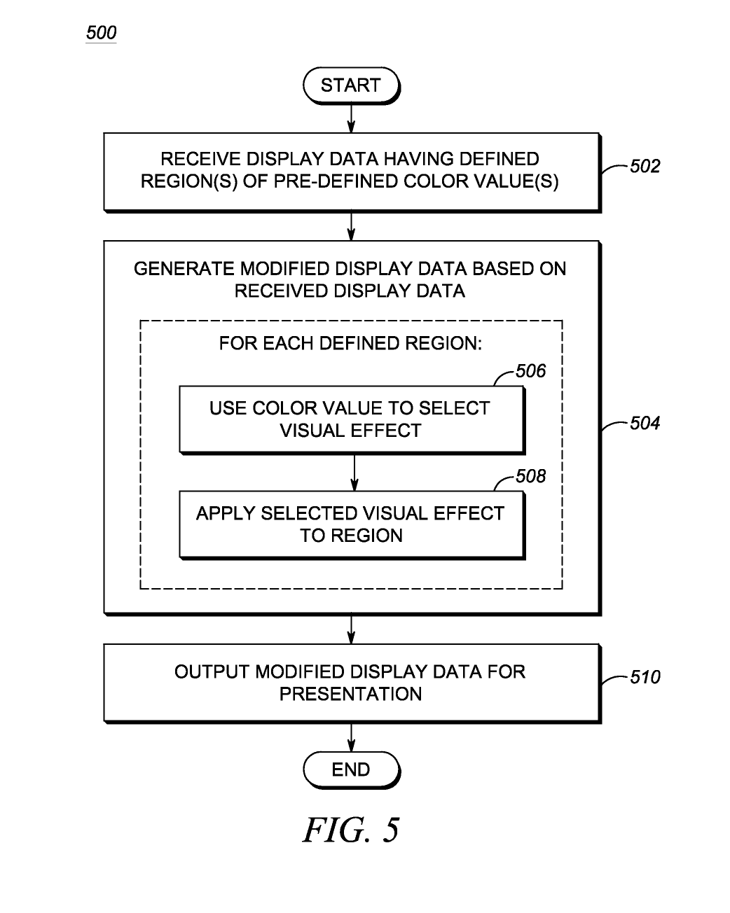

FIG. 5 depicts an example method 500 that may be carried out by a display controller, which may take on a number of different forms in various different implementations. In some cases, the display controller takes on the form of processor 304 executing instructions stored in program instructions 312. In some cases, those instructions could be or include what is known in the art as a display driver, and in some of those cases such a display driver may be updateable. Indeed, in some embodiments, the method 500 includes receiving and installing at least one update to the display driver. And certainly other forms of a display controller could be implemented in various different contexts, making use of any combination of one or more processors executing instructions encoded in any combination of hardware, firmware, and/or software deemed suitable by those of skill in the relevant art.

At 502, the display controller receives display data having defined therein one or more received-display-data regions of respective pre-defined color values.

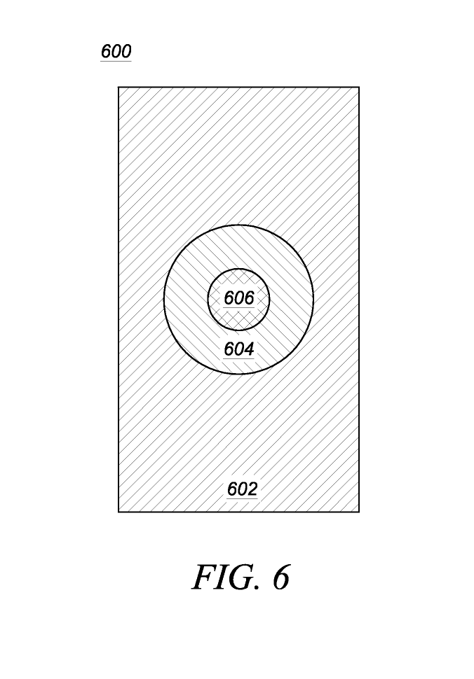

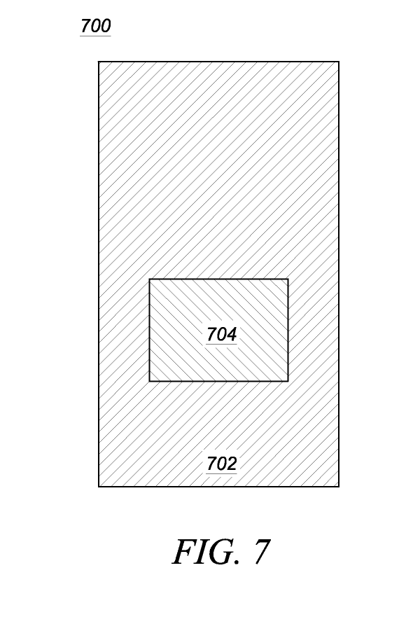

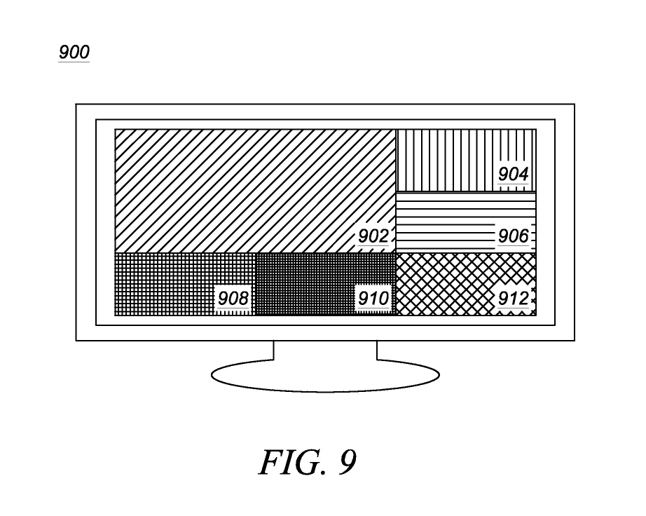

FIG. 6 depicts a first example of display data. In particular, FIG. 6 depicts example display data 600 as having three defined received-display-data regions 602, 604, and 606, where received-display-data region 602 may correspond with substantially all of a background of a user interface of an access terminal 200. Received-display-data region 604 is depicted by way of example as being substantially circular in shape and substantially centrally located among received display data 600. Received-display-data region 606 is depicted as also being substantially circular in shape, and as being overlaid substantially at the center of received-display-data region 604. In FIG. 6, as is the case in FIGS. 7 and 9, the different color values of the different received-display-data regions are depicted using different patterns of lines. In one example, the pre-defined color value of received-display-data region 602 corresponds to green, the pre-defined color value of received-display-data region 604 corresponds to pink, and the pre-defined color value of received-display-data region 606 corresponds to navy blue.

FIG. 7 depicts a second example of display data. In particular, FIG. 7 depicts example display data 700 as having two defined received-display-data regions 702 and 704, where received-display-data region 702 may correspond with substantially all of a background of a user interface of an access terminal 200. Received-display-data region 704 is depicted by way of example as being substantially rectangular in shape and as being overlaid on region 702 at a location that is horizontally centered and in a lower vertical half of region 702. In one example, the pre-defined color value of received-display-data region 702 corresponds to green, and the pre-defined color value of received-display-data region 704 corresponds to purple.

Returning to FIG. 5, in at least one embodiment, step 502 involves the display controller receiving the display data from an application. In at least one embodiment, step 502 involves the display controller receiving the display data from an operating system. In at least one embodiment, the display data has defined therein exactly one received-display-data region. In at least one embodiment, the display data has defined therein multiple received-display-data regions. In at least one embodiment, the one or more defined received-display-data regions includes a background region that corresponds in size and shape to substantially all of a background of the user interface.

In at least one embodiment, at least one of the pre-defined color values represents exactly one color (e.g., green). In at least one embodiment, at least one of the pre-defined color values represents a combination of colors (e.g., green and red, perhaps blended, perhaps arranged in a particular pattern, perhaps combined in some other way). In at least one embodiment, at least one of the pre-defined color values is a red-green-blue (RGB) color value (e.g., {0, 255, 0} (also expressed as 00FF00)). In at least one embodiment, at least one of the pre-defined color values is what is known as an alpha red green blue (ARGB) color value (e.g., 80FFFF00), where the alpha value pertains to opacity. In at least one embodiment, the pre-defined color value of at least one of the received-display-data regions reflects user input; for example, a user may select an option associated with a given visual effect, such as blurring or inverting a displayed image, and a given application and/or operating system may accordingly format display data having a region that of the appropriate color value, and pass that display data to the display controller.

At 504, the display controller generates modified display data based on the received display data. As depicted in FIG. 5, step 504 involves carrying out a pair of sub-steps with respect to each received-display-data region that is defined in the display data that is received at 502. The first of those two sub-steps is shown at 506, where the display controller uses the pre-defined color value of the received-display-data region to select a visual effect based on configuration data that maps various pre-defined color values to various visual effects.

As described above, an example of such configuration data is depicted at 400 in FIG. 4. Thus, if the received-display-data region being processed at the moment had a pre-defined color value of color_value_{—}01, the display controller may use that pre-defined color value to select visual_effect_{—}01 from the example configuration data 400. In at least one embodiment, method 500 involves the display controller accessing the configuration data from a configuration file. In at least one embodiment, method 500 involves the display controller receiving the configuration data from an application; in some such embodiments, the display controller received the display data from the same application at 502.

The second of those two sub-steps is shown at 508, where the display controller applies the selected visual effect to the current received-display-data region in a corresponding modified-display-data region in the modified display data. To continue the previous example, if the pre-defined color value of the current received-display-data region is color_value_{—}01, then the display controller would apply visual_effect_{—}01 to the current received-display-data region in a corresponding region in the modified display data. Thus, if visual_effect_{—}01 is, as was stated in an earlier example, “replace with feed from onboard video camera 308,” then the display controller in an embodiment would identify the region in the modified display data that corresponds in size, shape, and location to the currently-being-processed received-display-data region, and would augment the modified display data such that the video feed from camera 308 would then be displayed in that identified region in the modified display data.

And certainly numerous other examples of visual effects could be used, as deemed suitable and/or desirable by those of skill in the relevant art in various different implementations and contexts. In at least one embodiment, the selected visual effect is applied on a pixel-by-pixel basis, where each pixel of the currently-being-processed received-display-data region is replaced and/or altered according to the particulars of the selected visual effect; in one such example, each pixel of the received-display-data region is replaced by the corresponding pixel from a video feed from a video camera, which may be onboard or may be remote to the device.

In at least one embodiment, the selected visual effect includes one or more of zooming, blurring, blending, fading, pixel replacement, pixelating, distorting, bubbling, inversion, color inversion, mirroring, increasing opacity, decreasing opacity, and alpha blending. In at least one embodiment, applying the selected visual effect to the received-display-data region involves replacing the pre-defined color value with alternate display data. In at least one such embodiment, the alternate display data includes an image; and in at least one other such embodiment, the alternate display data includes a video feed from a video source.

The configuration data may associate the pre-defined color with the video source, and may further associate at least one other pre-defined color with at least one other video source. In at least one embodiment, the video source is an onboard video camera, where an access terminal (or other handheld wireless-communication device includes both the display controller and the onboard video camera. In such an embodiment, or perhaps in another, the currently-being-processed received-display-data region could be a background region that corresponds in size and shape to substantially all of a background of the corresponding user interface, such as user interface 306 of access terminal 200.

At 510, the display controller outputs the modified display data—generated at 504—for presentation via a user interface such as the user interface 306 of access terminal 200. In at least one embodiment, both the received display data and the modified display data correspond to a home screen of a computing device such as an access terminal 200. Furthermore, in at least one embodiment, the display controller additionally applies the selected visual effect to a set of pixels having (i) color values within a color tolerance of the pre-defined color value and (ii) locations within a spatial tolerance of the received-display-data region. That is, in at least one embodiment, the display controller may be arranged and configured to extend the application of the selected visual effect to nearby, similarly colored pixels.

Furthermore, in at least one embodiment, the display controller only carries out the method 500 when the display controller is configured to operate in a particular mode, which may be referred to as a color-substitution mode or perhaps by another name, where as a general matter the display controller can be selectively configured to operate in that mode and in at least one other mode; in one example, a display controller could be configured such that the functionality of the present methods and systems can be enabled or disabled using some manner of toggling switch, setting, or the like.

Briefly revisiting FIGS. 6 and 7 given the additional context provided above, in one embodiment the pre-defined color values of the regions of FIG. 6 indicate that region 602 be replaced with a video feed from camera 308, that region 606 be displayed as a navy blue circle, and that region 604 be displayed as navy blue at its innermost perimeter (still outside of region 606) and as color matching the current video at its outermost perimeter, and transitioning gradually from solid navy blue to lighter (e.g., more sparse, more blurry) from its innermost perimeter near its outermost perimeter. Furthermore, in one embodiment the pre-defined color values of the regions of FIG. 7 indicate that region 702 be replaced by an image from a stored image file and that region 704 be provided as a “zoom window” with respect to that image, such that a user can then use touchscreen gestures and/or other manners of user input to select which portion of the image is currently “zoomed in on” in the region corresponding to region 704 in the modified display data. And certainly other examples are possible and will occur to those of ordinary skill in the relevant art with respect to both color values and associated visual effects.

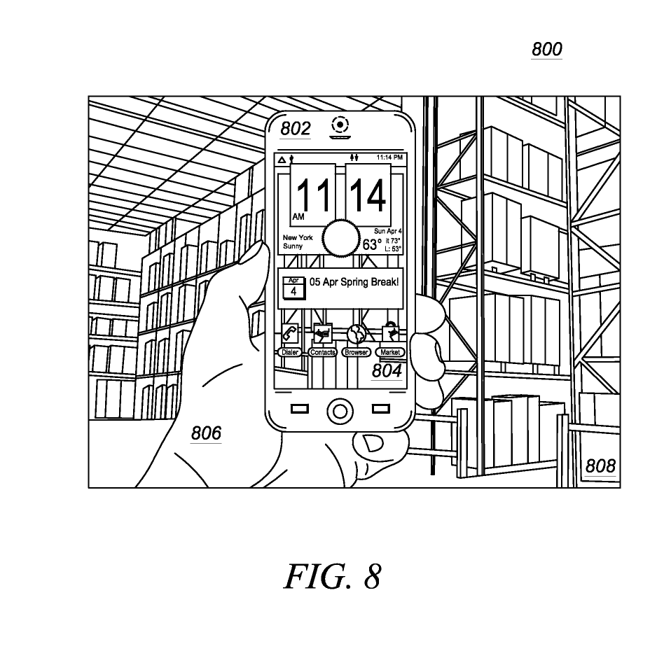

FIG. 8 depicts an example of an access terminal presenting modified display data. In this example, it can be seen that an access terminal 802 having a user-interface display 804 is being held in the hand 806 of a user. Furthermore, in this example, the access terminal 802 has a rear-facing video camera (not depicted) that is currently activated and is capturing video of a scene 808. In accordance with at least one embodiment of the present systems and methods, an operating system, or application, or home-screen widget, or the like, of the access terminal 802 may have put together a simple set of display data and sent that simple set of display data to the herein-described display controller.

That display data may have taken the form of the display data 600 of FIG. 6 without region 604 or 606, i.e. with only the background region 602. And that single display-data region may have been formatted by its sender (i.e., the operating system, application, home-screen widget, or the like) to have a pre-defined color value corresponding to a live video feed from the aforementioned rear-facing video camera of the access terminal 802.

As such, by operation of the present methods and systems, the sender of the simple display data was able to accomplish the result shown in FIG. 8, where a live video feed of what is being captured by the rear-facing video camera is displayed in conjunction with the other home-screen icons and widgets selected and arranged by the user of this particular access terminal, without the sender's developer needing to delve into and master the complexity of, among other complicated display-related application programming interfaces (APIs), the APIs of the rear-facing video camera.

Last among the figures is FIG. 9, which depicts a third example of display data, and is included in this disclosure for at least a few reasons, not to the exclusion of others. As a first reason, FIG. 9 reinforces the point made above that the present methods and systems could be carried out and implemented on a variety of types of computing devices, the above-focused-on access terminals being just an example. In particular, FIG. 9 depicts a computer monitor 900.

As a second reason, FIG. 9 also reinforces the point made above that different color values could be mapped by configuration data to multiple different video sources. Indeed, FIG. 9 shows six different display-data regions 902-912, represented in the corresponding display data by six different pre-defined color values represented by the six different line patterns depicted in FIG. 9. In an embodiment, each region 902-912 maps in the associated configuration data to a respective live video feed from a different remote video camera, all of which may be part of or at least accessible to a central system such as a home or office security system. By operation of the present methods and systems, then, developers of such a system could simply provide to the display controller a simple color map that resembles the arrangement shown in FIG. 9, and by so doing readily provide a complex and highly useful multiple-live-video-feed display to a user.

In the foregoing specification, specific embodiments have been described. However, one of ordinary skill in the art appreciates that various modifications and changes can be made without departing from the scope of the claims set forth below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as critical, required, or essential features or elements of any or all of the claims.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors (DSPs), customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all such functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, one or more embodiments can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. It is expected that one of ordinary skill, notwithstanding possibly significant effort and many design choices motivated by, for example, available time, current technology, and economic considerations, when guided by the concepts and principles disclosed herein will be readily capable of generating such instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This manner of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as separately claimed subject matter.

We claim:

1. A method carried out by a display controller, the display controller comprising a processor and non-transitory data storage containing instructions executable by the processor for causing the display controller to carry out the method, the method comprising:
receiving display data having defined therein one or more received-display-data regions of respective pre-defined color values;
generating modified display data based on the received display data; and
outputting the modified display data for presentation via a user interface,
wherein generating the modified display data based on the received display data comprises, with respect to each defined received-display-data region:
using the pre-defined color value of the received-display-data region to select a visual effect based on configuration data that maps various pre-defined color values to various visual effects, and
applying the selected visual effect to the received-display-data region in a corresponding modified-display-data region in the modified display data.

2. The method of claim 1, wherein the instructions comprise a display driver executable by the processor for causing the display controller to carry out the set of functions.

3. The method of claim 2, further comprising receiving and installing at least one update to the display driver.

4. The method of claim 1, wherein receiving the display data comprises receiving the display data from an application.

5. The method of claim 1, wherein receiving the display data comprises receiving the display data from an operating system.

6. The method of claim 1, wherein the display data has defined therein exactly one received-display-data region.

7. The method of claim 1, wherein the display data has defined therein multiple received-display-data regions.

8. The method of claim 1, wherein the one or more defined received-display-data regions includes a background region that corresponds in size and shape to substantially all of a background of the user interface.

9. The method of claim 1, wherein at least one of the pre-defined color values represents exactly one color.

10. The method of claim 1, wherein at least one of the pre-defined color values represents a combination of colors.

11. The method of claim 1, wherein at least one of the pre-defined color values is a red-green-blue (RGB) color value.

12. The method of claim 1, wherein at least one of the pre-defined color values is an alpha red green blue (ARGB) color value.

13. The method of claim 1, wherein the pre-defined color value of at least one of the received-display-data regions reflects user input.

14. The method of claim 1, further comprising accessing the configuration data from a configuration file.

15. The method of claim 1, further comprising receiving the configuration data from an application.

16. The method of claim 15, wherein receiving the display data comprises receiving the display data from the application.

17. The method of claim 1, wherein applying the selected visual effect comprises applying the selected visual effect on a pixel-by-pixel basis.

18. The method of claim 1, wherein the selected visual effect comprises one or more of zooming, blurring, blending, fading, pixel replacement, pixelating, distorting, bubbling, inversion, color inversion, mirroring, increasing opacity, decreasing opacity, and alpha blending.

19. The method of claim 1, wherein applying the selected visual effect to the received-display-data region comprises replacing the pre-defined color value with alternate display data.

20. The method of claim 19, wherein the alternate display data comprises an image.

21. The method of claim 19, wherein the alternate display data comprises a video feed from a video source.

22. The method of claim 21, wherein the configuration data associates the pre-defined color with the video source, wherein the configuration data associates at least one other pre-defined color with at least one other video source.

23. The method of claim 21, wherein the video source is an onboard video camera, wherein a handheld wireless-communication device comprises both the display controller and the onboard video camera.

24. The method of claim 23, wherein the received-display-data region is a background region that corresponds in size and shape to substantially all of a background of the user interface.

25. The method of claim 24, wherein both the received display data and the modified display data correspond to a home screen of a computing device.

26. The method of claim 1, wherein both the received display data and the modified display data correspond to a home screen of a computing device.

27. The method of claim 1, further comprising additionally applying the selected visual effect to a set of pixels having (i) color values within a color tolerance of the pre-defined color value and (ii) locations within a spatial tolerance of the received-display-data region.

28. The method of claim 1, carried out conditional on the display controller being configured to operate in a color-substitution mode, the display controller being configurable to operate in the color-substitution mode and instead in at least one other mode.

29. A display controller comprising:
a processor; and
non-transitory data storage containing instructions executable by the processor for causing the display controller to carry out a set of functions, the set of functions including:
receiving display data having defined therein one or more received-display-data regions of respective pre-defined color values;
generating modified display data based on the received display data; and
outputting the modified display data for presentation via a user interface,
wherein generating the modified display data based on the received display data comprises, with respect to each defined received-display-data region:
using the pre-defined color value of the received-display-data region to select a visual effect based on configuration data that maps various pre-defined color values to various visual effects, and
applying the selected visual effect to the received-display-data region in a corresponding modified-display-data region in the modified display data.

30. A display controller, wherein a handheld wireless-communication device comprises both the display controller and an onboard video camera, the display controller comprising:
a processor; and
non-transitory data storage containing instructions executable by the processor for causing the display controller to carry out a set of functions, the set of functions including:
receiving display data having defined therein a particular received-display-data region of a particular pre-defined color value;
generating modified display data based on the received display data; and
outputting the modified display data for presentation via a user interface,
wherein generating the modified display data based on the received display data comprises:
using the particular pre-defined color value of the particular received-display-data region to select the onboard video camera based on configuration data that maps at least one pre-defined color value to at least one video source, including mapping the particular pre-defined color value to the onboard video camera; and
replacing the particular pre-defined color value with a video feed from the onboard video camera in a corresponding modified-display-data region in the modified display data.
